(19) United States
(12) Patent Application Publication
(10) Pub. No.: US 2026/0175762 A1
(43) Pub. Date: Jun. 25, 2026

(54) BEVERAGE CONTAINER STORAGE DEVICE

(71) Applicant: TOYODA GOSEI CO., LTD., Kiyosu-shi (JP)

(72) Inventors: Kazuya IZAWA, Kiyosu-shi (JP); Kenji IIYA, Kiyosu-shi (JP)

(21) Appl. No.: 19/417,502

(22) Filed: Dec. 12, 2025

(30) Foreign Application Priority Data
Dec. 25, 2024 (JP) 2024-229526

(51) Int. Cl. B60N 3/10

(52) U.S. Cl. CPC B60N 3/106

(57) ABSTRACT

A beverage container storage device includes a holder member provided with an opening, a flap rotatable relative to the holder member, and a drive mechanism configured to rotate the flap to one side against a biasing force of a biasing member. The flap is composed of two flap portions each of which is biased about a different rotation shaft. The drive mechanism rotates one of the flap portions in the same rotation direction as in insertion of a container, against the biasing force of the biasing member in an initial stage of removing the container to an outside of the opening, so as not to hinder the removal.

### TECHNICAL FIELD

The present disclosure relates to a beverage container storage device mounted to an automobile or the like.

### BACKGROUND ART

Conventionally, a beverage container storage device for storing a beverage container is known (see, for example, U.S. Patent Application Publication No. 2005/0205590). A beverage container storage device described in U.S. Patent Application Publication No. 2005/0205590 includes a holder member, a flap, and a drive mechanism. The holder member has an opening that is provided in an upper portion thereof and into which a beverage container is capable of being inserted, and holds a beverage container inserted from the outside in the inside of the opening. The flap is rotatably supported by the holder member and is rotatable between an initial rotation position at which the flap front surface becomes horizontal and blocks at least a part of the opening and a use rotation position at which the flap front surface is inclined downward from a rotation shaft side to the tip of the flap and the opening area of the opening is larger than that at the initial rotation position. The drive mechanism has a rotation shaft about which the flap is rotated relative to the holder member and a biasing member that generates a biasing force for biasing the flap from the use rotation position side toward the initial rotation position side.

The above flap has two rotation flap portions. A first rotation flap portion that is one of these rotation flap portions is supported by a holder member so as to be rotatable about a first rotation shaft provided on the holder member side, and a second rotation flap portion that is the other of these rotation flap portions is supported by the first rotation flap portion so as to be rotatable about a second rotation shaft provided on the flap tip side of the first rotation flap portion. The second rotation flap portion is formed protruding on a side farther from the first rotation shaft than the flap tip of the first rotation flap portion.

The above biasing member has a first biasing portion that rotates the first rotation flap portion about the first rotation shaft relative to the holder member in a rotation direction approaching the orientation at the initial rotation position of the flap, and a second biasing member that rotates the second rotation flap portion about the second rotation shaft relative to the first rotation flap portion in the rotation direction approaching the orientation at the initial rotation position of the flap.

With the above beverage container storage device, when a beverage container is inserted into a storage space through the opening, a pressing force for pressing the flap downward is applied from the beverage container, whereby the first rotation flap portion is rotated relative to the holder member in a rotation direction in which the opening area of the opening is increased, and the second rotation flap portion is rotated relative to the first rotation flap portion in the rotation direction in which the opening area of the opening is increased.

If the outer diameter of the beverage container is large, the beverage container comes into contact with not only the second rotation flap portion but also the first rotation flap portion when the beverage container is inserted into the storage space, so that the beverage container having a large outer diameter is held, while the opening of the holder member is widened, by rotation of the first rotation flap portion about the first rotation shaft. On the other hand, if the outer diameter of the beverage container is small, the beverage container comes into contact with only the second rotation flap portion when the beverage container is inserted into the storage space, so that the beverage container having a small outer diameter is held by rotation of the second rotation flap portion about the second rotation shaft while rotation of the first rotation flap portion about the first rotation shaft is suppressed.

### SUMMARY OF INVENTION

### TECHNICAL PROBLEM

Meanwhile, there are beverage containers having a side profile with a constricted shape. Specifically, there are beverage containers in each of which the outer diameter of a container lower portion is large, the outer diameter of the container gradually decreases from the lower portion to a container central portion, and further, the outer diameter of the container gradually increases from the central portion to a container upper portion.

In a process in which the above beverage container having a constricted shape is inserted into the storage space through the opening, the flap tip of the flap (specifically, the second rotation flap portion) comes into contact with a portion, of the outer surface of the beverage container, having a large outer diameter from the initial rotation position in the initial stage of the insertion of the beverage container, so that the angle at which the flap front surface of the second rotation flap portion is inclined with respect to the horizontal direction gradually increases in the range of 90° or less as the insertion of the beverage container advances. Meanwhile, in the later stage of the insertion of the beverage container, the following situation may occur: the portion where the flap tip of the second rotation flap portion comes into contact with the outer surface of the beverage container reaches the portion where the outer diameter is the largest, and then gradually shifts to the portion having a smaller outer diameter, so that the angle at which the flap front surface is inclined with respect to the horizontal direction gradually decreases.

When the above situation occurs, in a process in which the beverage container inserted into the storage space is removed from the storage space, in a state where the second rotation flap portion is biased by the second biasing member so as to return to the original position with respect to the first rotation flap portion, the portion where the flap tip of the second rotation flap portion comes into contact with the outer surface of the beverage container shifts from the portion having a smaller outer diameter to the portion having a larger outer diameter in the beverage container, so that rotation of the second rotation flap portion in a rotation direction opposite to the direction of rotation by the biasing force of the second biasing member, against this biasing force, is possible, but no force resisting the biasing force of the first biasing member acts on the first rotation flap portion, and thus the first rotation flap portion rotates in a rotation direction in which the flap front surface returns to being horizontal.

As described above, in the above beverage container storage device, when the beverage container having a constricted shape is removed from the storage space, the first rotation flap portion changes to an orientation shape that hinders the beverage container from being removed, so that there is a possibility that the beverage container will not be smoothly removed.

The present disclosure has been made in view of the aforementioned circumstances, and an object of the present disclosure is to provide a beverage container storage device that, when a beverage container is removed from a storage space thereof, prevents a flap from shifting to an orientation shape that hinders the beverage container from being removed.

### SOLUTION TO PROBLEM

An aspect of the present disclosure is directed to a beverage container storage device including: a holder member provided with an opening into which a beverage container is capable of being inserted, the holder member being configured to hold the beverage container inserted from an outside to an inside of the opening; a plate-shaped flap supported by the holder member so as to be rotatable between an initial rotation position at which the flap blocks at least a part of the opening and a use rotation position at which an opening area of the opening is larger than that at the initial rotation position; and a drive mechanism having rotation shafts about which the flap rotates relative to the holder member and a biasing member configured to generate a biasing force for biasing the flap from the use rotation position side toward the initial rotation position side, the drive mechanism being configured to rotate the flap from the initial rotation position toward the use rotation position against a biasing force of the biasing member when a flap tip portion of the flap is pressed downward as the beverage container is inserted into the inside of the opening, wherein the flap has a first rotation flap portion supported by the holder member so as to be rotatable about a first rotation shaft that is one of the rotation shafts, and a second rotation flap portion supported by the first rotation flap portion so as to be rotatable about a second rotation shaft that is one of the rotation shafts and different from the first rotation shaft, the second rotation flap portion being formed protruding on a side farther from the first rotation shaft than a flap tip of the first rotation flap portion, the biasing member has a first biasing member configured to generate a biasing force for rotating the first rotation flap portion about the first rotation shaft relative to the holder member in a rotation direction approaching an orientation at the initial rotation position of the flap, and a second biasing member configured to generate a biasing force for rotating the second rotation flap portion about the second rotation shaft relative to the first rotation flap portion in the rotation direction approaching the orientation at the initial rotation position of the flap, and the drive mechanism rotates the first rotation flap portion in the same rotation direction as in insertion of the beverage container from the outside to the inside of the opening, against the biasing force of the first biasing member in an initial stage of removing the beverage container from the inside to the outside of the opening.

With this configuration, when a beverage container is removed from the storage space, the flap is prevented from shifting to an orientation shape that hinders the beverage container from being removed.

### BRIEF DESCRIPTION OF DRAWINGS

FIG. 1 is a perspective view of a main part of a beverage container storage device according to one embodiment of the present disclosure, from the front side;

FIG. 2 is a perspective view of the beverage container storage device of the embodiment, from the back side;

FIG. 3 is an exploded perspective view of the beverage container storage device of the embodiment;

FIG. 4 is a perspective view of a flap and a drive mechanism of the beverage container storage device of the embodiment at an initial rotation position from the back side;

FIG. 5 is a perspective view of the flap and the drive mechanism of the beverage container storage device of the embodiment at a use rotation position from the back side;

FIG. 6 is a cross-sectional view of the flap and the drive mechanism of the beverage container storage device of the embodiment at the initial rotation position;

FIG. 7 is a cross-sectional view of the flap and the drive mechanism of the beverage container storage device of the embodiment at the use rotation position;

FIG. 8 is a cross-sectional view of the flap and the drive mechanism of the beverage container storage device of the embodiment at an intermediate orientation position that is realized while a beverage container is removed from a storage space; and

FIG. 9 illustrates orientation changes of the flap and the drive mechanism of the beverage container storage device of the embodiment while the beverage container is removed from the storage space.

### DESCRIPTION OF EMBODIMENTS

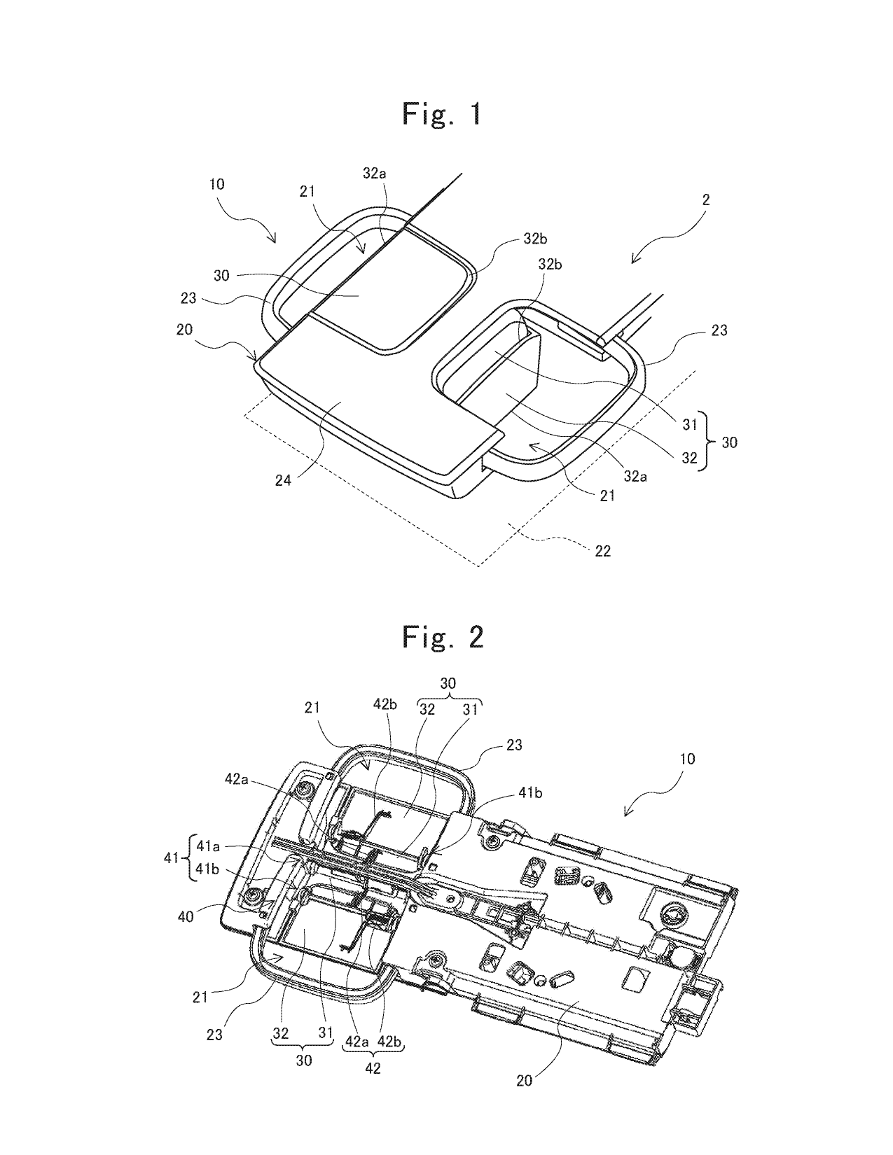

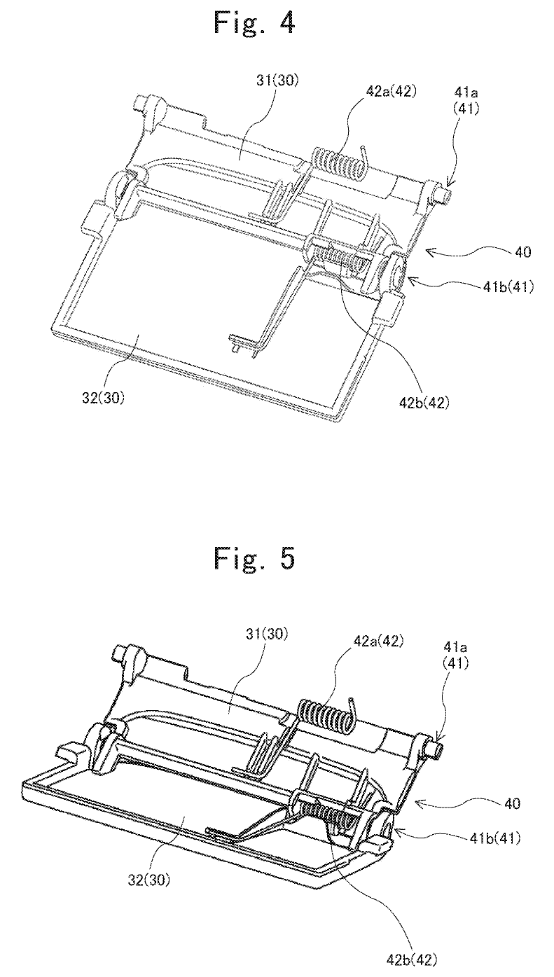

Hereinafter, a specific embodiment of the beverage container storage device according to the present disclosure will be described with reference to FIG. 1 to FIG. 9.

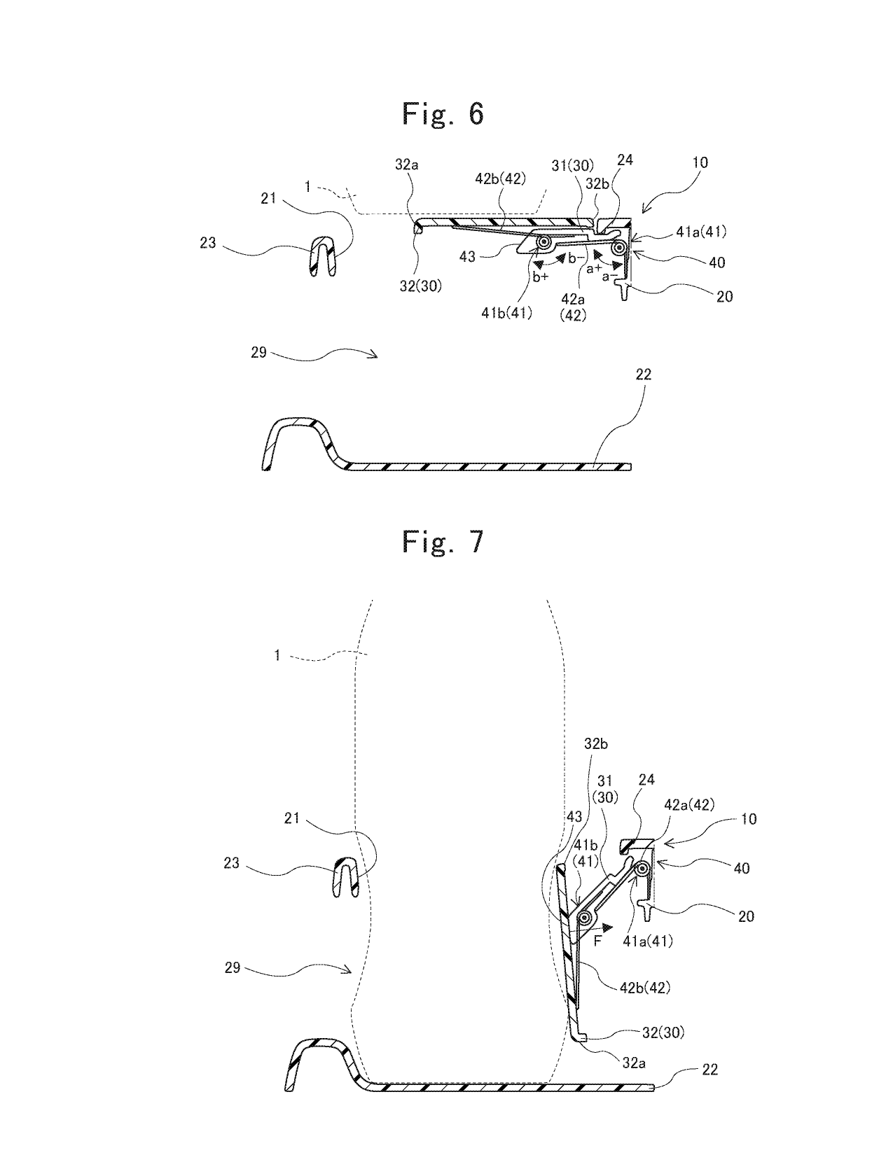

A beverage container storage device 10 according to one embodiment is a device capable of holding a beverage container 1 (see FIG. 6 to FIG. 8). The beverage container storage device 10 is mounted to a vehicle, for example. The beverage container 1 to be stored and held by the beverage container storage device 10 is, for example, a PET bottle, a can, a water bottle, and the like (especially, one whose side profile has a constricted shape). In addition, the beverage container 1 to be stored and held, for example, may have a size in the range of 6 cm to 9 cm in diameter or may have a height of up to about 300 mm or a capacity of up to about 1000 mL.

The beverage container storage device 10 may be capable of storing and holding a mobile terminal such as a smartphone or a mobile phone in addition to the beverage container 1. The beverage container storage device 10 may be mounted to a part other than a center console, but in the following, the beverage container storage device 10 is mounted to a center console 2 in the interior of the vehicle.

As shown in FIG. 1 and FIG. 2, the beverage container storage device 10 includes a holder member 20, a flap 30, and a drive mechanism 40. The center console 2 may be provided with a plurality of (two in the present embodiment) beverage container storage devices 10 independently.

The holder member 20 is a member for holding the beverage container 1. The holder member 20 is formed in a flat plate shape as the entirety or a part of the center console 2. The holder member 20 is provided with an opening 21. The opening 21 is an insertion port that opens upwardly and through which the beverage container 1 is capable of being inserted. The opening 21 is formed in a circular or quadrangular shape, for example. The size of the opening 21 is, for example, in the range of 80 mm to 90 mm and is preferably about 86 mm. The holder member 20 has a bottom wall 22 for supporting the lower surface of the beverage container 1 inserted from the outside (opening upper side) to the inside (opening lower side) of the opening 21. A storage space 29 for storing at least a part of the beverage container 1 is formed between the opening 21 and the bottom wall 22 of the holder member 20.

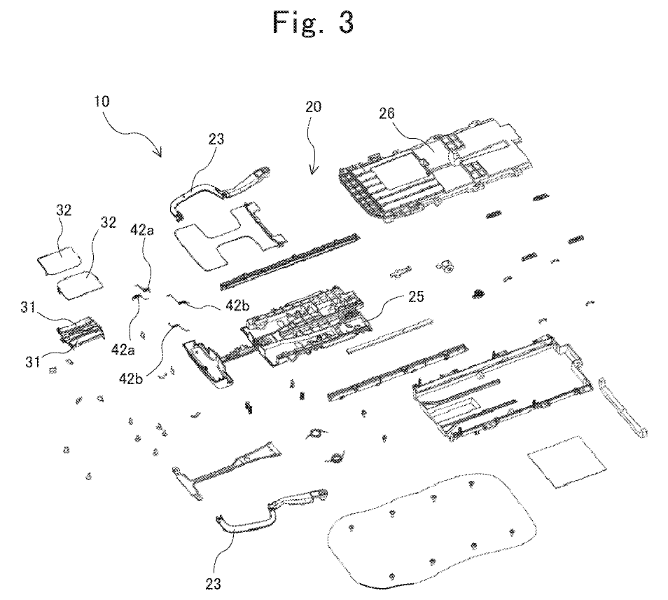

The holder member 20 may have a peripheral wall that surrounds the storage space 29, and in this case, the storage space 29 may be formed, for example, in a substantially circular column shape, a rectangular parallelepiped shape, or the like. Moreover, the holder member 20 may have a peripheral portion 23 (see FIG. 1, FIG. 2, etc.) of the opening 21 to support the beverage container 1. In addition, to support the beverage container 1, instead of using the bottom wall 22 which comes into contact with the lower surface of the beverage container 1, the holder member 20 may use the peripheral portion 23 of the opening 21 and the flap 30 to hold the side surface of the beverage container 1 therebetween. In addition, as shown in FIG. 3, the holder member 20 may be composed of a plurality of components, and may be configured, for example, by fitting and integrating a plate-shaped lower member 25 and a plate-shaped upper member 26 that are formed as separate members.

The flap 30 is a member capable of blocking at least a part of the opening 21. The flap 30 is formed in a planar plate shape (e.g., a quadrangular shape as shown in FIG. 1) in accordance with the shape of the opening 21. The flap 30 is capable of holding the beverage container 1 by coming into contact with the side surface of the beverage container 1 inserted into the opening 21 and pressing the beverage container 1 toward the opposite side across the opening 21. The flap 30 is rotatably supported by the holder member 20. The flap 30 rotates relative to the holder member 20 about a horizontal axis.

The flap 30 is rotatable between an initial rotation position and a use rotation position. The initial rotation position is a rotation position at which a flat flap front surface of the flap 30 faces upward and becomes horizontal to block at least a part of the opening 21. The flap front surface of the flap 30 may be flush with the upper surface of the center console 2 at the initial rotation position. The use rotation position is a rotation position at which the flat flap front surface of the flap 30 is inclined downward from the rotation shaft side to the flap tip end thereof and the opening area of the opening 21 is larger than that at the initial rotation position. The use rotation position includes a state where, as for the orientations of two rotation flap portions 31 and 32 described later, a flap front surface of at least one of the rotation flap portions 31 and 32 is not horizontal. The flap 30 is located at the initial rotation position in a normal state, and rotates toward the use rotation position when pressed downward from the upper side by the lower surface of the beverage container 1, etc.

As the flap 30, only one flap may be provided for one opening 21, but a plurality of flaps may be provided for one opening 21 so as to divide the opening 21 into a plurality of sections and such that the flaps are adjacent to and integrated with each other in the horizontal direction at the initial rotation position so as to be seen as one piece.

The flap 30 has the two rotation flap portions 31 and 32 that rotate about two rotation shafts 41a and 41b described later. That is, the flap 30 has a first rotation flap portion 31 and a second rotation flap portion 32. The first rotation flap portion 31 and the second rotation flap portion 32 are each formed in a plate shape. The first rotation flap portion 31 rotates about the rotation shaft 41a. The second rotation flap portion 32 rotates about the other rotation shaft 41b parallel to the rotation shaft 41a.

The drive mechanism 40 is a mechanism that rotates the flap 30 between the initial rotation position and the use rotation position. The drive mechanism 40 causes the first rotation flap portion 31 and the second rotation flap portion 32 to cooperate to change the opening area of the opening 21. The drive mechanism 40 has a rotation shaft 41, a biasing member 42, and a restriction portion 43.

The rotation shaft 41 is a shaft that extends in the horizontal direction. The rotation shaft 41 has the two rotation shafts 41a and 41b. The rotation shaft 41a and the rotation shaft 41b extend parallel to each other. The rotation shaft 41a and the rotation shaft 41b are provided, for example, at locations away from each other by about 20 mm. The rotation shaft 41a is a shaft about which the first rotation flap portion 31 is rotated relative to the holder member 20. The rotation shaft 41b is a shaft about which the second rotation flap portion 32 is rotated relative to the first rotation flap portion 31. Hereinafter, the rotation shaft 41a and the rotation shaft 41b are referred to as first rotation shaft 41a and second rotation shaft 41b, respectively.

The first rotation shaft 41a is placed below an upper wall 24 of the holder member 20. The height position of the first rotation shaft 41a remains unchanged relative to the holder member 20 and is set to a predetermined fixed height position. The height position of the first rotation shaft 41a is a height position that is, for example, about 80 mm above the bottom wall 22. The first rotation flap portion 31 is supported by the holder member 20 so as to be rotatable about the first rotation shaft 41a. The second rotation shaft 41b is placed on the flap tip side of the first rotation flap portion 31. The height position of the second rotation shaft 41b changes with respect to the holder member 20 in accordance with the rotation position of the first rotation flap portion 31. The second rotation flap portion 32 is supported by the first rotation flap portion 31 so as to be rotatable about the second rotation shaft 41b.

The first rotation flap portion 31 is formed such that, at the initial rotation position of the flap 30, while a flap back end portion on the first rotation shaft 41a side thereof is hidden below the upper wall 24 of the holder member 20, a flap tip portion thereof protrudes from the upper wall 24 side to the opening 21 side of the holder member 20. The second rotation flap portion 32 is located above the flap tip portion of the first rotation flap portion 31 so as to hide the flap tip portion of the first rotation flap portion 31 at the initial rotation position of the flap 30. As shown in FIG. 6, the second rotation flap portion 32 is formed and placed such that, at the initial rotation position of the flap 30, the flap front surface thereof spreads horizontally, is exposed upward from the opening 21, and blocks at least a part of the opening 21.

When the two beverage container storage devices 10 are arranged in a back-to-back orientation as shown in FIG. 1 to FIG. 3, the two first rotation flap portions 31 may be integrated, and the first rotation shaft 41a may be shared by these two first rotation flap portions 31.

The second rotation flap portion 32 has a portion that is formed protruding on a side farther from the first rotation shaft 41a than the flap tip of the first rotation flap portion 31. That is, the distance from the first rotation shaft 41a to a flap tip 32a of the second rotation flap portion 32 is larger than the distance from the first rotation shaft 41a to the flap tip of the first rotation flap portion 31. The second rotation flap portion 32 is formed such that, at the use rotation position of the flap 30, the distance between the flap tip 32a thereof and the bottom wall 22 of the holder member 20 with which the lower surface of the beverage container 1 comes into contact (or the lower surface of the supported beverage container 1 when the beverage container 1 is supported by being held between the peripheral portion 23 of the opening 21 and the flap 30) is equal to or less than a predetermined distance.

The above predetermined distance is ideally set to 0 mm so as to accommodate all beverage containers 1 to be supported, but may be 1.5 mm or less, for example. Setting the above predetermined distance to at least a distance smaller than the maximum diameter height distance of the beverage container 1 having a longest distance (maximum diameter height distance) from the bottom wall 22 of the holder member 20 (or the lower surface of the held and supported beverage container 1) to a portion where the outer diameter thereof is maximized around the lower surface of the beverage container 1 among all the beverage containers 1 to be supported, is effective.

The biasing member 42 is a member that generates a biasing force for biasing the flap 30 from the use rotation position side toward the initial rotation position side. The biasing member 42 has a first biasing member 42a and a second biasing member 42b. The first biasing member 42a and the second biasing member 42b are, for example, springs, respectively. The flap 30 may be restricted from changing an orientation thereof to the side opposite to the use rotation position with respect to the initial rotation position, regardless of the biasing force of the first biasing member 42a and the biasing force of the second biasing member 42b.

The first biasing member 42a is interposed between the holder member 20 and the first rotation flap portion 31. The first biasing member 42a is configured such that one end portion thereof is engaged with the holder member 20 and another end portion thereof is engaged with the first rotation flap portion 31. The first biasing member 42a is a biasing member that generates a biasing force for rotating the first rotation flap portion 31 about the first rotation shaft 41a relative to the holder member 20 in a predetermined rotation direction a+ (see FIG. 6). The predetermined rotation direction a+ is a rotation direction in which the first rotation flap portion 31 approaches the orientation at the initial rotation position of the flap 30 with respect to the holder member 20 (specifically, the orientation in which the flap front surface of the first rotation flap portion 31 is horizontal). When the beverage container 1 is inserted from the upper side to the lower side of the opening 21 of the holder member 20, the first rotation flap portion 31 rotates in a rotation direction a- (see FIG. 6) opposite to the above predetermined rotation direction a+, against the biasing force of the first biasing member 42a due to the pressing force from the beverage container 1.

The second biasing member 42b is interposed between the first rotation flap portion 31 and the second rotation flap portion 32. The second biasing member 42b is configured such that one end portion thereof is engaged with the first rotation flap portion 31 and another end portion thereof is engaged with the second rotation flap portion 32. The second biasing member 42b is a biasing member that generates a biasing force for rotating the second rotation flap portion 32 about the second rotation shaft 41b relative to the first rotation flap portion 31 in a predetermined rotation direction b+ (see FIG. 6). The predetermined rotation direction b+ is a rotation direction in which the second rotation flap portion 32 approaches the orientation at the initial rotation position of the flap 30 with respect to the first rotation flap portion 31 (specifically, the orientation in which the flap front surface of the second rotation flap portion 32 is horizontal). When the beverage container 1 is inserted from the upper side to the lower side of the opening 21 of the holder member 20, the second rotation flap portion 32 rotates in a rotation direction b- (see FIG. 6) opposite to the above predetermined rotation direction b+, against the biasing force of the second biasing member 42b due to the pressing force from the beverage container 1.

When the flap tip portion of the flap 30 is pressed downward as the beverage container 1 is inserted into the inside of the opening 21 of the holder member 20, the drive mechanism 40 rotates the flap 30 in the rotation directions a- and b- from the initial rotation position toward the use rotation position, against the biasing force of the biasing member 42. In addition, the drive mechanism 40 is capable of rotating the first rotation flap portion 31 in the same rotation direction a- as in the insertion of the beverage container 1 from the outside to the inside of the opening 21, against the biasing force of the first biasing member 42a in the initial stage of removing the beverage container 1 from the inside to the outside of the opening 21.

The restriction portion 43 is a portion that restricts the second rotation flap portion 32 from rotating relative to the first rotation flap portion 31 about the second rotation shaft 41b by more than a predetermined angle α (see FIG. 9). The restriction portion 43 is provided to the first rotation flap portion 31. Specifically, the restriction portion 43 is provided to the flap tip of the first rotation flap portion 31 and placed in the vicinity of the second rotation shaft 41b. The predetermined angle α is set, for example, to about 45° based on an angle at which the flap front surface of the second rotation flap portion 32 spreads at the initial rotation position. The restriction portion 43 is a surface portion capable of coming into surface contact with a flap back surface, of the second rotation flap portion 32, facing downward at the initial rotation position and is inclined with respect to the flap front surface of the second rotation flap portion 32 at the initial rotation position.

The drive mechanism 40 is configured such that an angle of the flap front surface of the second rotation flap portion 32 with respect to the vertical direction is changeable from a positive angle on the initial rotation position side to a negative angle on the opposite side across zero in a process of rotating the flap 30 from the initial rotation position toward the use rotation position (see FIG. 6 to FIG. 8). That is, the angle of the flap front surface of the second rotation flap portion 32 with respect to the vertical direction is +90° at the initial rotation position and is changeable to a negative angle across zero at the use rotation position. This negative angle is, for example, greater than 0° and equal to or less than about 45°.

In other words, the drive mechanism 40 is configured such that an angle of the flap front surface of the second rotation flap portion 32 with respect to the horizontal direction in the process of rotating the flap 30 from the initial rotation position toward the use rotation position is changeable from 0° at the initial rotation position to an angle greater than 90° (e.g., greater than 90° and equal to or less than 135°) (see FIG. 6 to FIG. 8). The second rotation flap portion 32 is configured such that an upper portion thereof is located toward the inside of the beverage container 1 at the use rotation position rather than a lower portion thereof.

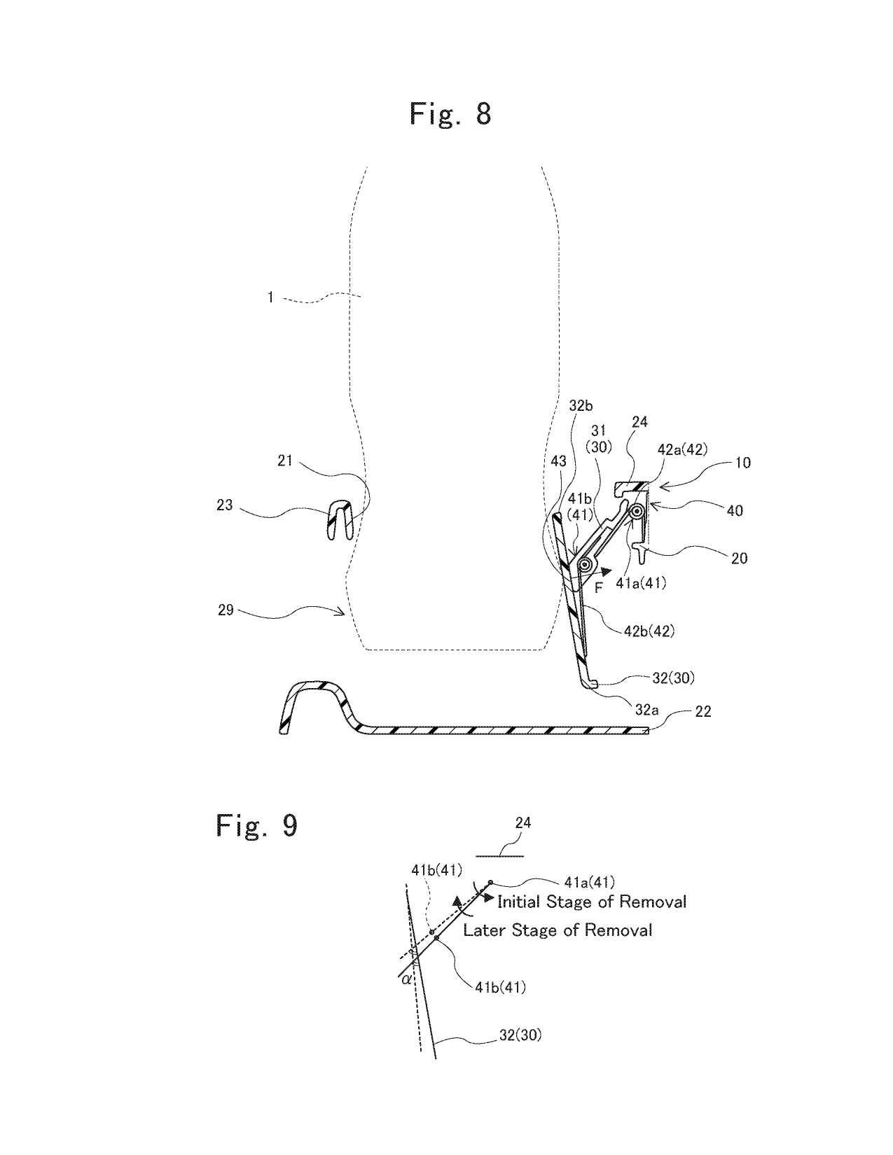

In the above drive mechanism 40, when the beverage container 1 inserted into the inside of the opening 21 is removed to the outside of the opening 21, in the initial stage of removal, a force generated due to the removal is applied to the contact surface, of the restriction portion 43, with the second rotation flap portion 32 in a state where the flap back surface of the second rotation flap portion 32 is in contact with the restriction portion 43, and the first rotation flap portion 31 rotates in the rotation direction a- due to a partial force F (see FIG. 7 and FIG. 8) of this force. That is, in the initial stage of removing the beverage container 1, while the second rotation flap portion 32 is restricted from rotating relative to the first rotation flap portion 31 in the rotation direction b- by more than the predetermined angle α by the restriction portion 43, the second rotation flap portion 32 and the first rotation flap portion 31 rotate together in the rotation direction a- about the first rotation shaft 41a (see FIG. 7 to FIG. 9).

Next, the operation of the beverage container storage device 10 will be described.

In the beverage container storage device 10, when the beverage container 1 is not inserted from the outside to the inside of the opening 21 of the holder member 20 and is not stored in the storage space 29, the flap 30 is at the initial rotation position at which the flap front surface thereof becomes horizontal (see FIG. 6).

When a vehicle occupant or the like is to place the beverage container 1 in the beverage container storage device 10 at the initial rotation position of the flap 30, the vehicle occupant or the like inserts the beverage container 1 from the outside (opening upper side) to the inside (opening lower side) of the opening 21 of the holder member 20. When the beverage container 1 is inserted into the inside of the opening 21, first, the lower surface of the beverage container 1 comes into contact with the flap front surface of the flap 30, and the flap 30 is pressed downward by the beverage container 1 and rotates in the rotation directions a- and b- about the rotation shaft 41 against the biasing force of the biasing member 42.

Specifically, when the first rotation flap portion 31 of the flap 30 is pressed downward from the upper side by the beverage container 1 (e.g., when the outer diameter of the beverage container 1 is large (specifically, when the outer diameter is larger than the distance from the flap tip of the first rotation flap portion 31 to the peripheral portion 23 of the opening 21 at the initial rotation position)), in the initial stage of the insertion of the beverage container 1, the second rotation flap portion 32 is not tilted with respect to the first rotation flap portion 31, and the first rotation flap portion 31 and the second rotation flap portion 32 rotate together in the rotation direction a- about the first rotation shaft 41a. At this time, as the insertion of the beverage container 1 advances, the inclination angles of the first rotation flap portion 31 and the second rotation flap portion 32 with respect to the horizontal direction gradually increase, and the effective diameter and the opening area of the opening 21 gradually increase.

Then, when the inclination angle of the first rotation flap portion 31 with respect to the horizontal direction reaches a predetermined angle, only the second rotation flap portion 32 then rotates in the rotation direction b- about the second rotation shaft 41b relative to the first rotation flap portion 31 as the insertion of the beverage container 1 advances. The above predetermined angle corresponds to the outer diameter and the outer shape of the beverage container 1, and, for example, the predetermined angle increases as the outer diameter increases. The rotation of only the second rotation flap portion 32 is continued until the second rotation flap portion 32 is restricted by the restriction portion 43. Then, when the second rotation flap portion 32 is restricted by the restriction portion 43, the first rotation flap portion 31 and the second rotation flap portion 32 then rotate together in the rotation direction a- about the first rotation shaft 41a while maintaining the angle difference from the predetermined angle α.

On the other hand, when the first rotation flap portion 31 of the flap 30 is not pressed downward from the upper side by the beverage container 1 (e.g., when the outer diameter of the beverage container 1 is small (specifically, when the outer diameter is smaller than the distance from the flap tip of the first rotation flap portion 31 to the peripheral portion 23 of the opening 21 at the initial rotation position)), in the initial stage of the insertion of the beverage container 1, the first rotation flap portion 31 is not tilted with respect to the holder member 20, and only the second rotation flap portion 32 rotates in the rotation direction b- about the second rotation shaft 41b relative to the first rotation flap portion 31. At this time, as the insertion of the beverage container 1 advances, the inclination angle of the second rotation flap portion 32 with respect to the first rotation flap portion 31 gradually increases, and the effective diameter and the opening area of the opening 21 gradually increase.

Then, when the second rotation flap portion 32 is restricted by the restriction portion 43, the first rotation flap portion 31 and the second rotation flap portion 32 then rotate together in the rotation direction a- about the first rotation shaft 41a while maintaining the angle difference from the predetermined angle α.

When the lower surface of the beverage container 1 comes into contact with the bottom wall 22 of the holder member 20 as a result of the beverage container 1 being inserted as described above, the rotation of the first rotation flap portion 31 and the second rotation flap portion 32 in the rotation directions a- and b- stops, and the beverage container 1 is then held in the storage space 29 in a state where the inclination angles of the first rotation flap portion 31 and the second rotation flap portion 32 with respect to the horizontal direction are maintained by the weight of the beverage container 1 (see FIG. 7).

When the beverage container 1 is held in the storage space 29, the flap front surface of the flap 30 is inclined downward with respect to the horizontal direction. If the side profile of the beverage container 1 has a straight shape in which the outer diameter does not change regardless of the height position, the angle of the flap front surface of the second rotation flap portion 32 with respect to the horizontal direction merely changes in a range from 0° at the initial rotation position to 90° in the process in which the flap 30 rotates from the initial rotation position toward the use rotation position. Meanwhile, if the side profile of the beverage container 1 has a constricted shape in which the outer diameter changes in accordance with the height position (specifically, the outer diameters of the container lower portion and the container upper portion are large and the outer diameter of the container central portion gradually decreases), in the process in which the flap 30 rotates from the initial rotation position toward the use rotation position, the angle of the flap front surface of the second rotation flap portion 32 with respect to the horizontal direction changes from 0° to an angle greater than 90° when the flap tip 32a of the second rotation flap portion 32 comes into contact with the side surface of the container lower portion having a large outer diameter and a flap back end 32b of the second rotation flap portion 32 enters a constricted portion of the container central portion having a small outer diameter.

When the angle of the flap front surface of the second rotation flap portion 32 with respect to the vertical direction has changed from 0° to an angle greater than 90° as described above, if the beverage container 1 is pulled out from the storage space 29 and withdrawn from the inside to the outside of the opening 21, first, the portion, of the flap front surface of the second rotation flap portion 32 at a negative angle with respect to the vertical direction, with which the beverage container 1 comes into contact gradually shifts from the flap tip 32a side to the flap back end 32b side of the second rotation flap portion 32 (see FIG. 7 and FIG. 8). During this shift, the second rotation flap portion 32 is pressed by the force F in a direction in which the opening 21 becomes larger, while remaining in contact with the restriction portion 43 of the first rotation flap portion 31.

When this force F acts on the second rotation flap portion 32, while the second rotation flap portion 32 is restricted from rotating in the rotation direction b- relative to the first rotation flap portion 31 by more than the predetermined angle α by the restriction portion 43, the first rotation flap portion 31 and the second rotation flap portion 32 rotate together in the rotation direction a- about the first rotation shaft 41a. As the first rotation flap portion 31 and the second rotation flap portion 32 rotate together in the rotation direction a-, the effective diameter and the opening area of the opening 21 gradually increase.

Then, when the effective diameter of the opening 21 increases to a diameter that allows the beverage container 1 to be removed (i.e., the maximum diameter of the beverage container 1), removing the entire beverage container 1 to the outside of the opening 21 becomes possible, then, the second rotation flap portion 32 rotates in the rotation direction b+ relative to the first rotation flap portion 31 and returns to the original position due to the biasing force of the second biasing member 42b, the first rotation flap portion 31 rotates in the rotation direction a+ relative to the holder member 20 and returns to the original position due to the biasing force of the first biasing member 42a, and the flap 30 returns to the initial rotation position.

As described above, in the beverage container storage device 10, in the initial stage of removing the beverage container 1 from the inside to the outside of the opening 21, the first rotation flap portion 31 is rotated by the drive mechanism 40 in the same rotation direction a- as in the insertion of the beverage container 1 from the outside to the inside of the opening 21, against the biasing force of the first biasing member 42a. If the first rotation flap portion 31 rotates in the same rotation direction a- as in the insertion of the beverage container 1 when the beverage container 1 is removed, the effective diameter of the opening 21 increases, the opening 21 widens, and the flap 30 (specifically, the first rotation flap portion 31) changes to an orientation shape in which the beverage container 1 is easily removed.

Therefore, the beverage container storage device 10 prevents the flap 30 (specifically, the first rotation flap portion 31) from shifting to an orientation shape that hinders the beverage container 1 from being removed, when the beverage container 1 (especially, the beverage container 1 having a constricted shape) is removed from the storage space 29. Thus, the beverage container 1 to be removed from the storage space 29 is less likely to become caught on the flap tip 32a of the second rotation flap portion 32, and removing the beverage container 1 from the inside to the outside of the opening 21 is facilitated, so that the beverage container 1 is smoothly removed. In addition, damage of the drive mechanism 40, the flap 30, etc., due to the beverage container 1 becoming caught on or pressed into the flap tip of the flap 30 when the beverage container 1 is removed from the storage space 29, is prevented.

The present disclosure is not limited to the above-described embodiment and modifications, and various changes may be made without departing from the gist of the present disclosure. In addition, the present specification discloses not only the technical concept indicated by the citation relationship between the claims as originally filed, but also the technical concept obtained by combining the matters recited in each claim as appropriate.

This application claims priority on Japanese Patent Application No. 2024-229526 filed on December 25, 2024, the entire contents of which are incorporated herein by reference.

1. A beverage container storage device comprising:
a holder member provided with an opening into which a beverage container is capable of being inserted, the holder member being configured to hold the beverage container inserted from an outside to an inside of the opening;
a plate-shaped flap supported by the holder member so as to be rotatable between an initial rotation position at which the flap blocks at least a part of the opening and a use rotation position at which an opening area of the opening is larger than that at the initial rotation position; and
a drive mechanism having rotation shafts about which the flap rotates relative to the holder member and a biasing member configured to generate a biasing force for biasing the flap from the use rotation position side toward the initial rotation position side, the drive mechanism being configured to rotate the flap from the initial rotation position toward the use rotation position against a biasing force of the biasing member when a flap tip portion of the flap is pressed downward as the beverage container is inserted into the inside of the opening, wherein
the flap has
a first rotation flap portion supported by the holder member so as to be rotatable about a first rotation shaft that is one of the rotation shafts, and
a second rotation flap portion supported by the first rotation flap portion so as to be rotatable about a second rotation shaft that is one of the rotation shafts and different from the first rotation shaft, the second rotation flap portion being formed protruding on a side farther from the first rotation shaft than a flap tip of the first rotation flap portion,
the biasing member has
a first biasing member configured to generate a biasing force for rotating the first rotation flap portion about the first rotation shaft relative to the holder member in a rotation direction approaching an orientation at the initial rotation position of the flap, and
a second biasing member configured to generate a biasing force for rotating the second rotation flap portion about the second rotation shaft relative to the first rotation flap portion in the rotation direction approaching the orientation at the initial rotation position of the flap, and
the drive mechanism rotates the first rotation flap portion in the same rotation direction as in insertion of the beverage container from the outside to the inside of the opening, against the biasing force of the first biasing member in an initial stage of removing the beverage container from the inside to the outside of the opening.

2. The beverage container storage device according to claim 1, wherein the drive mechanism has a restriction portion provided to the first rotation flap portion and configured to restrict the second rotation flap portion from rotating relative to the first rotation flap portion about the second rotation shaft by more than a predetermined angle, and is configured such that an angle of a flap front surface of the second rotation flap portion with respect to a horizontal direction is changeable from 0° at the initial rotation position to an angle greater than 90° in a process of rotating the flap from the initial rotation position toward the use rotation position.

3. The beverage container storage device according to claim 1, wherein the second rotation flap portion is formed such that a distance between the flap tip and a bottom wall, of the holder member, with which a lower surface of the beverage container comes into contact is equal to or less than a predetermined distance at the use rotation position of the flap.
